(19) United States
(12) Patent Application Publication
(10) Pub. No.: US 2023/0328329 A1
(43) Pub. Date: Oct. 12, 2023

(54) USER-CHOSEN, OBJECT GUIDED REGION OF INTEREST (ROI) ENABLED DIGITAL VIDEO

(71) Applicant: ITTIAM SYSTEMS (P) LTD., Bangalore (IN)

(72) Inventors: SHAILESH RAMAMURTHY, Bangalore (IN); MURALI BABU MUTHUKRISHNAN, Bangalore (IN); SHEELA PRABHAKAR, Bangalore (IN)

(21) Appl. No.: 18/130,459

(22) Filed: Apr. 4, 2023

(30) Foreign Application Priority Data
Apr. 4, 2022 (IN) 202241020333

(51) Int. Cl. H04N 21/4722; H04N 21/61; H04N 21/437; H04N 21/81

(52) U.S. Cl. CPC H04N 21/4722; H04N 21/437; H04N 21/6125; H04N 21/8133

(57) ABSTRACT

In an example, a method may include providing, via an application, a first video stream on a display panel of a user device. Further, the method may include receiving, from a user, a selection of an object of interest associated with a portion of the first video stream. In response to receiving the selection, the method may include providing additional visual information corresponding to the object of interest. Further, the method may include rendering a region of interest on the display panel using the additional visual information and the region of interest including the object. Upon rendering the region of interest, the method may include tracking movements of the object in the region of interest across video frames.

### TECHNICAL FIELD

The present disclosure relates to streaming of multimedia content, and more particularly to methods, techniques, and systems for user-chosen, object guided region of interest (ROI) enabled digital video.

### BACKGROUND

With evolving streaming multimedia (e.g., video) technologies such as hypertext transfer protocol (HTTP)-based adaptive bitrate (ABR) streaming, users are moving from linear television (TV) content consumption to non-linear, on demand, time-shifted, and/or place-shifted consumption of content. In such digital video streaming, object of interest (OOI) or a region of interest (ROI) video features may enhance a user video experience. The term object of interest is intended to refer to an object, person, animal, region, or any video feature of interest. For example, some mobile clients support a basic functionality of zooming into arbitrary rectangular regions of digital video.

### BRIEF DESCRIPTION OF THE DRAWINGS

FIG. 1A is a block diagram of an example video processing system, including an object-based video processing module capable of providing additional visual information corresponding to an object;

FIG. 1B is a block diagram of another example video processing system, depicting a server-client scenario including an object-based video processing module deployed in a serving entity, client device, or both;

FIG. 2 is a flow diagram illustrating an example method for rendering a region of interest on a display panel based on additional visual information;

FIG. 3 is a block diagram of an example video processing system to render a region of interest on a display panel;

FIG. 4 is a block diagram of another example system, depicting a server-client scenario to display video frames of a video stream such that a chosen object/region of interest is shown in a zoomed-in view;

FIGS. 5A and 5B are flow diagrams illustrating an example method for rendering a region of interest on a display panel based on additional visual information;

FIG. 6 is a block diagram of an example system, including a client device processing a region of interest by requesting for an appropriate variant of ABR stream by augmenting client device’s switching-logic;

FIG. 7A is a block diagram of an example system, including an adaptation logic to provide an appropriate scalable video coding (SVC) stream with enhanced visual details of an object to a client device;

FIG. 7B is a schematic diagram, illustrating an enhancement layer of the scalable video coding scheme;

FIG. 7C is a schematic diagram, illustrating another example enhancement layer of the scalable video coding scheme;

FIG. 8 is a block diagram of an example system, depicting processing of a 360 degree-video for rendering a user-selected object of interest on a client device;

FIG. 9 is a block diagram of an example system, depicting stitching of multiple views coming from different camera feeds in Multiview video coding (MVC) technologies to render and track the object of interest;

FIG. 10 shows an indicative object and two traditional rectangular partitions, within which the triangular or trapezoidal or wedge shape splits help in aligning to the boundaries of the object closely; and

FIG. 11 is a block diagram of an example video processing system including non-transitory computer-readable storage medium storing instructions to render a region of interest on a display panel using additional visual information.

The drawings described herein are for illustration purposes only and are not intended to limit the scope of the present subject matter in any way.

### DETAILED DESCRIPTION

The paragraphs [0016] to [0020] describe about an overview of digital video, existing methods to view object of interest (OOI) in the digital video, and drawbacks associated with existing methods. Digital video is an electronic representation of moving visual images in the form of encoded digital data. In such a digital video, automatically zoom in on a visual object or a region of the video scene for user interest may enhance user experience. For example, for a sport video, a user to view in an athlete of interest in more detail or with more information; for a movie or TV show, a user to highlight his or her favorite actor; for a travel channel, a user to zoom into a specific scene region; for a shopping channel, a user to enlarge a special item; for a training video, the user to enlarge a part or piece of equipment.

In digital images, the basic touch-based zooming and panning control of images may be sufficient for the user to get to his/her object of interest interactively, given the static nature of an image (i.e., along with its constituent objects). In a digital video, the objects move within a video and a naïve touch-based zooming in may not allow the user to zoom into moving objects. Thus, unlike image viewing/rendering tools, the full potential of scaling digital video using touch-based (e.g., zoom and pinch) interactive controls of a mobile client may be challenging. Some example video players may provide zooming of digital video in an arbitrary rectangular window approximately obtained as per user’s interactive zooming controls on a mobile client. However, such a feature may not be available as ubiquitously as in case of images viewed on mobiles. Further, mobile video players may not support a ready mechanism for the user to choose an object he/she is interested in zooming into, and even tracking as the object moves within the video. Thus, some mobile clients may support a basic functionality of zooming into arbitrary rectangular regions of digital video, but such functionality is not object-based. Hence, constitutes a noticeable gap between user expectations and support available.

Further, even in case of naïve zoom-in controls available on a few digital video players on mobiles, zooming into any region of interest may degrade perceptible quality with respect to perceptible quality of the original video. Thus, existing implementations may not take advantage of higher bitrate/resolution variants available upon request, in any adaptive bitrate streaming delivery. Further, zooming into any specific resolution and bitrate and viewing a scaled-up version may not be as effective in quality and user-experience, as what could have been rendered in higher perceived quality obtained from higher bitrate/resolution variants of adaptive bitrate streams.

Furthermore, when there are multiple video feeds such that an object is available partially in each/some of multiple views coming from different camera feeds, there is no existing implementation available to the viewer to see the complete object in a zoomed fashion to allow him/her to track the complete object as the object moves. Also, across frames, it may be possible in some segments (e.g., a set of frames), that the object is completely in one view or the other(s), while in some others, it may be only partial. Thus, multiple views may have to be stitched together to render and track the object completely.

Workplace video collaboration (also called workplace video conferencing) tools such as MS Teams and Zoom have become increasingly popular. During communication using such video collaboration tools, there may be no existing method for an individual participant to choose demarcated objects to zoom into a specific region of interest where the user may want to examine details of a chosen object within the video or other visual media that is being communicated over the tool. Such viewing of the chosen object of interest may enable a specific user’s interest in wanting to examine the detailed information within an object and potentially tracking the object.

Examples described herein may provide a method for rendering a region of interest on a display panel based on additional visual information. The method may include providing a first video stream on a display panel of a user device via an application. Further, the method may include receiving a selection of an object of interest associated with a portion of the first video stream from a user. In response to receiving the selection, the method may include providing additional visual information corresponding to the object of interest. For example, the additional visual information may include one of an enhancement layer of a scalable video coding (SVC) scheme, a higher adaptive bitrate streaming (ABR) variant, an object mask identifying the object, metadata associated with the object, object-based coded stream representing objects, and multi-view information in Multiview coding (MVC) scheme. Further, the method may include rendering a region of interest on the display panel using the additional visual information and the region of interest including the object. Upon rendering the region of interest, the method may include tracking movements of the object in the region of interest across video frames.

In the following description, for purposes of explanation, numerous specific details are set forth to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

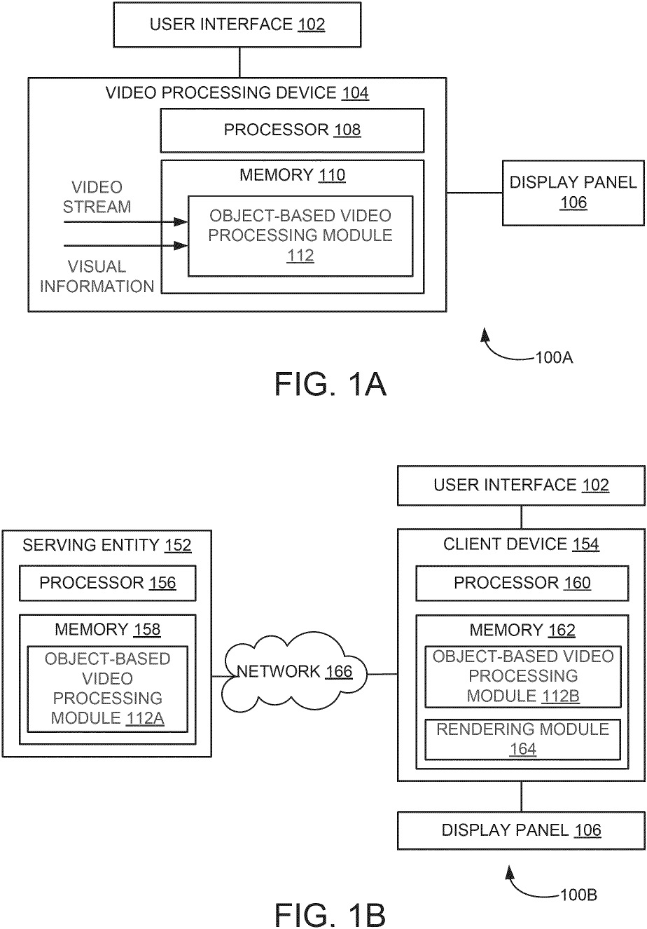

Turning now to the figures, FIG. 1A is a block diagram of an example video processing system 100A, including an object-based video processing module 112 capable of providing additional visual information corresponding to an object. Example video processing system 100A is any system for providing video (including, but not limited to, an educational system, a training system, a design system, a simulator, a gaming system, a home theater, a television, an augmented realty system, a remote auction system, a virtual reality system, and a live video meeting system). Video processing system 100A may include a user interface 102, a video processing device 104, and a display panel 106. Further, video processing device 104 may include processor 108 and memory 110 coupled to processor 108. Processor 108 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 108 may, for example, include single or multiple cores on a chip, multiple cores across multiple chips, multiple cores across multiple devices, or suitable combinations thereof. Processor 108 may be functional to fetch, decode, and execute instructions as described herein.

Video processing system 100A may provide object of interest processing for video playback, in some examples. In an example, video processing system 100A may use video processing device 104 to process user inputs to provide the additional visual information for user selected objects of interest. Further, the video including the additional visual information may be provided on display panel 106 for viewing by a user.

In an example, video processing device 104 may receive video frames associated with a first video stream from a source. The source can be any source of video including, but not limited to, a media player, a cable provider, an internet subscription service, a headend, a video camera, a stored media server, a satellite provider, a set top box, a video recorder, a computer, or other source of video material.

The first video stream processed by video processing device 104 can be in the form of video frames provided from a media server or client device. For example, the media server may include a set-top box (STB) that can perform digital video recorder functions, a home or enterprise gateway, a server, a computer, a workstation, and the like. The client device may include a television, a computer monitor, a mobile computer, a projector, a tablet, or a hand-held user device (e.g., a smart phone), and the like. Further, the media server or client device may be configured to output audio, video, program information, and other data to video processing device 104.

Further, video processing system 100A may include components interconnected by a wired connection or a wireless connection (e.g., a wireless network). For example, the connection can include a coaxial cable, a BNC cable, a fiber optic cable, a composite cable, a s-video, a DVI, a HDMI, a VGA, a DisplayPort, or other audio and video transfer technologies. The wireless network connection can be a wireless local area network (WLAN) and can use Wi-Fi in any of its various standards. In some examples, video processing device 104 may be implemented as a single chip or a system on chip (SOC). Further, the detection of objects of interest and provision of indicators and enhanced video may be provided in real time.

In some examples, video processing device 104 may include one or more decoding units, display engines, transcoders, processors, and storage units (e.g., frame buffers, memory, and the like). Further, video processing device 104 may include one or more microprocessors, digital signal processors, CPUs, application specific integrated circuits (ASICs), programmable logic devices, servers and/or one or more other integrated circuits. Furthermore, video processing device 104 can include one or more processors (e.g., processor 108) that can execute instructions stored in memory 110 for performing the functions described herein. The storage units include, but are not limited to disk drives, servers, dynamic random-access memories (DRAMs), flash memories, memory registers or other types of volatile or non-volatile fast memory. Further, video processing device 104 can include other components not shown in FIG. 1A. For example, video processing device 104 can include additional buffers (e.g., input buffers for storing compressed video frames before they are decoded by the decoders), network interfaces, controllers, memory, input and output devices, conditional access components, and other components for audio/video/data processing.

In some examples, video processing device 104 can provide video streams in a number of formats (e.g., different resolutions (e.g., 1080p, 4 K or 8 K), frame rates (e.g., 60 fps vs. 30 fps), bit precisions (e.g., 10 bits vs. 8 bits), or other video characteristics. For example, the received video stream or provided video stream associated with the video processing device 104 includes a 4 K Ultra High Definition (UHD) (e.g., 3840×2160 pixels or 2160p) or even 8 K UHD (7680×4320) video stream.

Display panel 106 can be any type of screen or viewing medium for video signals from video processing device 104. For example, display panel 106 may be a liquid crystal display (LCD), a plasma display, a television, a computer monitor, a smart television, a glasses display, a head worn display, a projector, ahead up display, or any other device for presenting images to the user. Further, display panel 106 may be a part of or connected to a simulator, a home theater, a set top box unit, a computer, a smart phone, a smart television, a fire stick, a home control unit, a gaming system, an augmented realty system, a virtual reality system or other video system.

An example user interface 102 can be a smart phone, a remote control, a microphone, a touch screen, a tablet, a mouse, a head-mounted display or any user device with position and motion sensing capabilities used for consuming AR/VR/360-video, or any device for receiving user inputs such as selections of objects of interest which can include regions of interest and types of video enhancements. During operation, user interface 102 may receive a command from the user to start an object of interest or region of interest selection process on a set top box unit or recorder in some examples. For example, user interface 102 can include a far field voice interface or a push to talk interface, a game controller, a button, a touch screen, or other selectors. Further, user interface 102 can be a part of a set top box unit, a computer, a television, a smart phone, a fire stick, a home control unit, a gaming system, an augmented realty system, a virtual reality system, a computer, or other video system.

Further, video processing device 104 may include object-based video processing module 112 residing in memory 110 and executable by processor 108. During operation, object-based video processing module 112 may provide, via an application, the first video stream on display panel 106. For example, the application may be a video player, a set-top box (STB) unit, an online collaboration tool, and the like. In an example, object-based video processing module 112 may receive video frames associated with the first video stream from the source. For example, the first video stream may include a file on a file system in video processing device 104 (e.g., a client device), an Internet video that is being delivered over an internet protocol in a managed network or in an over-the-top (OTT), and a video within a video collaboration tool, whereby the user zooms into a specific object/region of interest to examine details of the video or the objects that the video contains, infographics, text, or other visual media being communicated via the video collaboration tool. Further, object-based video processing module 112 may render the received video frames on display panel 106.

Further in operation, object-based video processing module 112 may receive, from a user, a selection of an object of interest associated with a portion of the first video stream. In an example, a client device may operate in conjunction with a touch-screen interface, a remote control, a mouse, a gaze detection sensor, a gesture detection sensor, a sound source localization technique based on a plurality of audio/voice signals, or other input to allow the user to select the region of interest.

In response to receiving the selection, object-based video processing module 112 may provide additional visual information corresponding to the object of interest. In an example, the additional visual information may include one of an enhancement layer of a scalable video coding (SVC) scheme, a higher adaptive bitrate streaming (ABR) variant, an object mask identifying the object, metadata associated with the object, an object-based coded stream representing objects, and multi-view information in Multiview Coding (MVC) scheme. In an example, the additional visual information may be generated at the client/user device that consumes/displays the first video stream or at a serving entity that serves the first video stream.

Further, object-based video processing module 112 may render the region of interest on display panel 106 using the additional visual information. The region of interest may include the object. Upon rendering the region of interest, object-based video processing module 112 may track movements of the object contained in the region of interest across video frames. For example, movements of the object may be tracked on a frame-by-frame basis, once in 2 frames, once in 3 frames, once in 4 frames, and the like). In an example, tracking the movements of the object contained in the region of interest may include tracking the object as the object moves or changes across the video frames and rendering the tracked object in a zoomed-in view. Object tracking may be used to automatically adjust and indicate the objects or regions of interest in the subsequent frames during video play, in some examples, in a zoomed view or with enhanced visual information (e.g., high quality video data) compared to other regions of the frames. In this example, object-based video processing module 112 may automatically track the selected object or region of interest in subsequent frames during video play.

In some examples, the functionalities described in FIG. 1A, in relation to instructions to implement functions of object-based video processing module 112 and any additional instructions described herein in relation to the storage medium, may be implemented as engines or modules including any combination of hardware and programming to implement the functionalities of the modules or engines described herein. The functions of object-based video processing module 112 may also be implemented by a processor. In examples described herein, the processor may include, for example, one processor or multiple processors included in a single device or distributed across multiple devices.

FIG. 1B is a block diagram of another example video processing system 100B, depicting a server-client scenario including an object-based video processing module (e.g., object-based video processing module 112 of FIG. 1A) deployed in a serving entity 152 (e.g., object-based video processing module 112A), client device 154 (e.g., object-based video processing module 112B), or both. Similarly labelled elements of FIG. 1B may be similar in structure and/or function to elements described in FIG. 1A. For example, the functionalities of object-based video processing module 112 can be implemented at serving entity 152 that serves the video streams, at client device 154 that renders the video streams, or at both serving entity 152 and client device 154 such that serving entity 152 and client device 154 can work together to perform the functions described herein.

As shown in FIG. 1B, serving entity 152 may include a processor 156 and memory 158 coupled to processor 156. Memory 158 may include object-based video processing module 112A. In another example, client device 154 may include a processor 160 and memory 162 coupled to processor 160. Memory 162 may include object-based video processing module 112B and a rendering module 164.

In some examples, serving entity 152 and client device 154 may be communicatively connected via a network 166. Example network 166 can be a managed Internet protocol (IP) network administered by a service provider. For example, network 166 may be implemented using wireless protocols and technologies, such as Wi-Fi, WiMAX, and the like. In other examples, network 166 can also be a packet-switched network such as a local area network, wide area network, metropolitan area network, Internet network, or other similar type of network environment. In yet other examples, network 166 may be a fixed wireless network, a wireless local area network (LAN), a wireless wide area network (WAN), a personal area network (PAN), a virtual private network (VPN), an intranet or other suitable network system and includes equipment for receiving and transmitting signals.

In an example, the video stream processed by client device 154 can be in the form of video frames provided from serving entity 152. Examples described in FIG. 1B may enable viewers of video streams to select one or more particular objects of interest on client device 154. The regions of interest may be stationary or may move across frames being rendered on display panel 106. A user of client device 154 may select an object of interest and client device 154 may report the selection to serving entity 152. Further, serving entity 152 may receive an indication of the region or regions selected by client device 154 and use object-based video processing module 112A to generate and the send the additional visual information corresponding to the object of interest to the user. In this example, rendering module 164 in client device 154 may render the region of interest including the object using the additional visual information on display panel 106.

In another example, object-based video processing module 112B residing in client device 154 can receive an indication of the region or regions selected and generate the additional visual information corresponding to the object of interest. In yet another example, object-based video processing module 112A in serving entity 152 and object-based video processing module 112B in client device 154 can work in collaboration to generate and render the additional visual information corresponding to the object of interest.

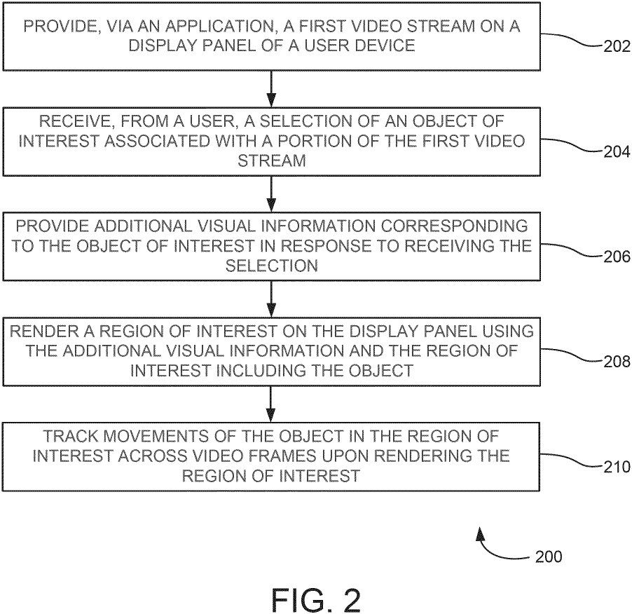

FIG. 2 is a flow diagram illustrating an example method 200 for rendering a region of interest on a display panel based on additional visual information. At 202, a first video stream may be provided, via an application (e.g., a media player), on the display panel of a user device. The first video stream may include a file on a file system in the user device, an Internet video that is being delivered over an internet protocol in a managed network or in an over-the-top (OTT), or a video within a video collaboration tool. Further, the user may zoom into a specific object/region of interest to examine details of the video, infographics, text, and the like. The first video stream may be associated with an augmented reality (AR), virtual reality (VR), 360° video, or gaming application. AR/VR/360° video can be experienced using dedicated head mounted displays. Alternatively, they can be experienced using some of the position and motion sensors available widely on user devices or mobile clients (e.g., a gyroscope, an accelerometer, a magnetometer, a proximity sensor, and the like).

For example, the first video stream may include digital video that is encapsulated in adaptive bitrate streams, on which the region of interest would be achieved using client-side processing. The adaptive bitrate streams may include chunks of video data, each chunk encapsulating independently decodable Advanced Video Coding (AVC), High Efficiency Video Coding (HEVC), AOMedia Video (AV1 or AV2), or Versatile Video Coding (VVC).

At 204, a selection of an object of interest associated with a portion of the first video stream may be received from a user. The object may be obtained based on partitions contained in the first video stream. The first video stream may be a compressed video stream containing I-frame data, P-frame data, B-frame data, or any combination thereof.

In response to receiving the selection, at 206, additional visual information corresponding to the object of interest may be provided. The additional visual information may include one of an enhancement layer of a scalable video coding (SVC) scheme, a higher adaptive bitrate streaming (ABR) variant, an object mask identifying the object, metadata associated with the object, object-based coded stream representing objects, multi-view information in Multiview Coding (MVC) scheme, and the like.

At 208, a region of interest may be rendered on the display panel using the additional visual information. The region of interest may include the object. Based on the additional visual information, high quality video frames may be generated using a deep learning based super resolution to render the object of interest on the user device. The additional visual information may be generated at the user device or at a serving entity that serves the first video stream. In an example, an artificial intelligence (AI)-based analysis tool may be used to enable recognition and segmentation of the object of interest in the first video stream and determine a window that covers the object of interest. The recognition and segmentation can be performed at the serving entity that generates the first video stream or at the user device that displays the first video stream.

In an example, deep learning-based techniques can be used both at client and server-side. Firstly, deep learning-based techniques are used for the video analysis that leads to the required segmentation of selectable objects. Deep learning tools can be used for identification and tracking of objects and also automatically determining the exact window that covers the object of interest. In an example, deep learning tools can be used at the server. In another example, deep learning tools can be used at the client device, especially when the client device has required horsepower available for the computation. On the client device’s side, scaling and panning to enable zooming into a region of interest and scalar solution using deep learning based super resolution can be deployed to generate high quality video frames.

In the above example, the client device may detect objects using the device’s own horsepower. Latest as well as future video encoded streams support partitions and splits for coding that are closely aligned to the object boundaries. Accordingly, while decoding the video, one preferred embodiment of the client uses the notion of the object boundaries by post-processing the partitions (which are aligned to the object boundary), using edge linking and boundary tracing algorithms. In clients with AI acceleration, another preferred example uses such information in conjunction with various objects which have been learned by the client. In another preferred example, the client uses AI and deep learning to segment the objects without using the information of partitions from the encoded bitstream of video.

Upon rendering the region of interest, at 210, movements of the object in the region of interest may be tracked across video frames. In an example, the object may be tracked as the object moves or changes across the video frames and rendering the tracked object in a zoomed-in view across the video frames.

### ABR Streams-based Client-side Region of Interest Processing

In an example scenario, rendering the region of interest on the display panel may include:
In response to receiving the selection of the region of interest, sending a request for the additional visual information to the server.
Based on the request, receiving a second video stream directed to the same video content as the first video stream. The second video stream may include the additional visual information. The additional visual information may include a higher bitrate/resolution variant including enhanced visual details to enable the user to zoom into the object of interest on the display screen.
Rendering the region of interest associated with a portion of the second video stream on the display screen.

In the above example, the server may send ABR streams (e.g., each chunk of which encapsulates independently decodable AVC/HEVC/AV1). The client device processes the region of interest by requesting for an appropriate ABR variant stream by augmenting its switching-logic, in addition to video processing (e.g., scaling and cropping) as per need. Examples described herein may be applicable in OTT and video collaboration applications.

### Boundary-based Client-side Region of Interest Processing And Object Tracking

In another example scenario, rendering the region of interest on the display panel may include:
In response to receiving the selection of the region of interest:
   ◯ Detecting a plurality of objects in the first video stream.
   ◯ Determining an object of the plurality of objects that corresponds to the region of interest.
   ◯ Generating the additional visual information corresponding to the determined object. The additional visual information may include one of a geometric boundary around the object, the enhancement layer of the scalable video coding (SVC) scheme, and the object mask identifying the object.
   ◯ Panning and zooming the first video stream to display the object on the display screen based on the additional visual information.

In the above example, when the user clicks on, or close to, object(s) of interest, the client device detects the objects in the video-frame and maps the user-choice to an appropriate object. The client device may include specific capabilities and horsepower to perform the region of interest computation. A bounding region (e.g., a bounding box) of the object forms the region of interest. The user experience is that of tracking the object of interest through the bounding region. The bounding region could also be in the form of a circle or ellipse. Examples described herein may be envisioned on monolithic streams (e.g., AVC, AV1, and the like), however, can be extended to ABR streams. Examples described in this example may be applicable in OTT applications.

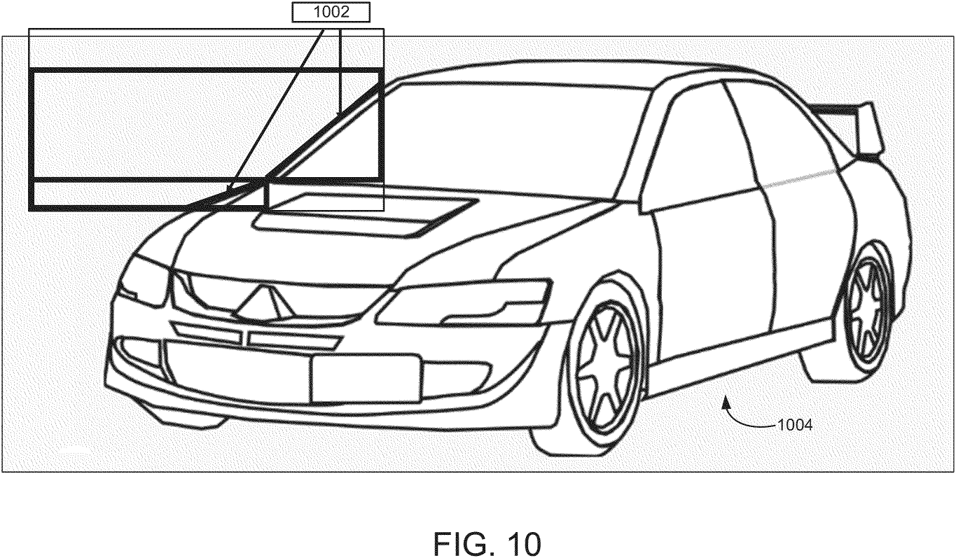

In the above example, the client device may detect objects using the device’s own horsepower. The video encoded streams may use partitions and splits for coding that are closely aligned to the object boundaries. Accordingly, while decoding the video, one preferred example of the client uses the notion of the object boundaries by post-processing the partitions (which are aligned to the object boundary), using edge linking and boundary tracing algorithms. In clients with AI acceleration, the client device uses such information in conjunction with various objects which have been learned by the client device. In another example, the client uses AI and deep learning to segment the objects without using the information of partitions from the encoded bitstream of video. An example edge linking and boundary tracing is explained with respect to FIG. 10.

### Metadata-based Region of Interest Processing and Object Tracking

In yet another example scenario, rendering the region of interest on the display panel may include:
Receiving, from a server, the first video stream along with the additional visual information associated with objects in the first video stream. The additional visual information may include the metadata including a position information of the objects across video frames of the first video stream that can be used to track the movement of the object. The server may stream the metadata about locations of objects of interest along with the standard monolithic stream (e.g., AVC / AV1). As the object of interest moves within the video frame, the client continuously receives the updated location information through the metadata.
In response to receiving the selection of the region of interest, rendering the region of interest including the object using the metadata associated with the object.

For example, the object is signaled to the user device in the form of the metadata conveying a geometrical boundary of the object. In another example, the object is signaled to the user device in the form of the metadata conveying the boundaries of the object in the form of the object mask. In yet another example, the metadata can be conveyed within supplemental enhancement information in Advanced Video Coding (AVC) or MPEG video standards, or as the AV1 Open Bitstream Unit (OBU).

In the above example, the server detects objects and creates metadata about the object locations, within the frames of the video streams (e.g., AVC, AV1, and the like). For example, the metadata identifies the top-left and bottom-right corner of the bounding-box for the objects, in terms of macroblock indices, or pixel coordinates. The metadata could also convey the center and radius of a circular boundary of the object of interest. The metadata can also convey the shape and position of an elliptical boundary of the object of interest, with parameters such as aspect ratio, size, aces information, center of ROI boundary, and the like. The server serves the standard streams (e.g., AVC, AV1, and the like) along with the said metadata. When the user at the client device clicks on, or close to, object(s) of interest, this information along with the received metadata information is used to identify and render the geometrical boundary of the specific object. In this example, the received metadata may be used to determine a geometrical boundary around the object or the object mask of the object. Further, the first video stream may be panned and zoomed according to the geometrical boundary or the object mask to display the region of interest including the object on the display panel. In this example, the server can also detect objects, generate required metadata, and additionally encode a certain set of objects of interest (to a potential user) with a higher bitrate.

### Object Coded Streams-based Region of Interest Processing And Object Tracking

In yet another example scenario, rendering the region of interest on the display panel may include:
Receiving, from the server, the first video stream along with the additional visual information. The additional visual information may include object-based coded streams representing objects in the first data stream.
In response to receiving the selection of the object of interest, panning, and zooming the first video stream to display a boundary of the object on the display screen, the boundary including an object-based coded stream representing a zoomed portion of the object. In this example, rendering the region of interest may include rendering arbitrarily shaped object-based coded streams with boundaries demarcated at pixel level or partition-block level.

In the above example, the server codes the objects in the form of video-object-plane. For coding the objects, the server may require the compression standard/technology to support coding of the video-objects. For instance, MPEG-4 Part 2 allows object-based access to the video objects, as well as temporal instances of the video objects (i.e., VOPs). A video object is an arbitrarily shaped video segment that has a semantic meaning. A 2D snapshot of a video object at a particular time instant is called a video object plane (VOP). To enable access to an arbitrarily shaped object, a separation of the object from the background and the other objects has to be performed. This can be achieved by deep learning or classical segmentation techniques. When user at client clicks on, or close to, object(s) of interest, this information along with the received object plane(s) is used to identify and render the specific object. In one example, the geometric boundary of the object can be presented at the client device’s display panel. In another example specifically suited for AR/VR/gaming, the client can choose and render arbitrarily shaped objects whose boundaries are demarcated at pixel level or macro-block level.

Examples described herein related to the object-based coded streams for the region of interest may be applicable in specialized OTT (e.g., where there is a wide-angle or long-shot view, from which the client requests for a rectangular crop that follows object of interest), AR/VR/360, gaming, personalized videos. For example, while viewing a football match, a viewer may be interested in Team A players compared to Team B players. Upon receiving such a request, the server can encode such objects (Team A players) giving more bits or degrade the audience but show the players clearly. In OTT too, certain objects can have more bits than others, in certain recipes.

### Scalable Video Coding (SVC)-based Region of Interest Processing And Object Tracking

In yet another example scenario, rendering the region of interest on the display panel may include:
Providing the first video stream including a base layer of the scalable video coding scheme on the display screen, and
In response to receiving the selection of the region of interest, providing the additional visual information including the at least one enhancement layer of the scalable video coding scheme on the display screen. The at least one enhancement layer may provide details associated with the object of interest.

In the above example, the server codes video as scalable video (e.g., SVC, AV1 scalable extension, SHVC, and the like). The base layer may provide basic representation while the enhancement layer provides refinement information that may be required by certain clients for their ROI. Enhancement layer can be requested as per the need by the client device. In an example, the client device can use previously decoded information (e.g., from base layer or previous enhancement layers) along with the current enhancement layer information to get finer visual details of the region of interest. The region of interest may be a geometrical boundary (e.g., a rectangle bounding box, a circle, or an ellipse) of the chosen object, given the rectangular coding structures used by SVC. In other examples, the SVC can be designed for the region of interest on objects which have arbitrarily shaped boundaries, demarcated at pixel or macroblock level, which can be applicable for gaming and AR/VR applications.

### Multiview Coding-based Region of Interest Processing and Object Tracking

In yet another example scenario, when the object is available partially in multiple views captured from different camera feeds in Multiview coding (MVC) technologies, the views may be registered and stitched together to form the object, which is then rendered and tracked in the region of interest.

Furthermore, in some examples, feedback associated with the object of interest selected by the user may be received. The received feedback may be used for further analytics pertaining to the object of interest.

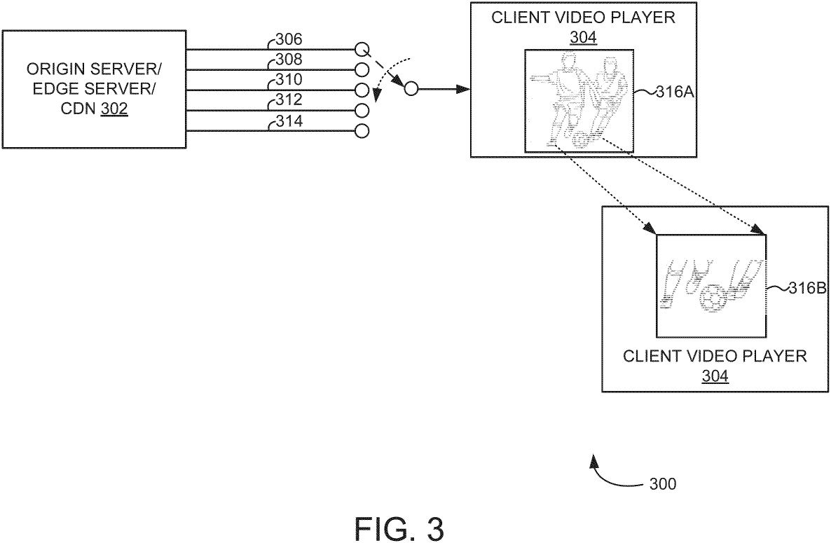

FIG. 3 is a block diagram of an example video processing system 300 to render a region of interest on a display panel (e.g., a video player 304 on a client device). Example video processing system 300 may include a serving entity (e.g., 302) such as an origin server, an edge server, a content delivery network, or the like.

The video player 304, upon receiving a user request for region of interest for zooming into a portion of video being played, can function in any of the below modes:
Zoom (up/down scale) and pan the current video to serve the region of interest to the client device’s display.
In case of OTT delivery where the video provided by serving entity 302 includes different ABR streams, the client device fetches a different quality/resolution stream and does decode, zoom/scale, and pan as required.

The client device (or the video player) upon receiving a user request for tracking an object of interest in the video being played, can function in any of the below modes:
In client devices with the necessary processing capabilities: The bounding region (which could be a rectangular bounding box or other shapes such as a circle or ellipse) of the objects of interest form the chosen rectangular region of interest, with provision for zoom and pan on the region of interest. The movement of objects of interest within the video frame are continuously tracked.
Server aided object of interest tracking: The objects within a video stream/frame that can be tracked as objects of interest by the client are predetermined at the serving entity 302. The serving entity 302 streams either the metadata about locations of objects of interest along with the standard monolithic stream (AVC/AV1) or customized object-based coded streams. With this, the client device identifies the region of interest from the decoded video and further supports zoom and pan as may be needed. As other examples, apart from the aforementioned bounding regions (regular geometric shapes such as rectangular bounding boxes or circles or ellipses) as the possible regions of interest, object-based region of interest (arbitrarily shaped objects at pixel or macro-block level) is supported.

A serving entity 302 with necessary updates can respond to the client requests of the region of interest by encoding the objects of interest using a higher bitrate in the standard monolithic stream (AVC / HEVC / AV1). Alternatively, serving entity 302 can encode the video as multiple layers (base + enhancement) using the scalable extensions of the codec standard. In these cases, when a user selects objects of interest, serving entity 302 responds by streaming video wherein there is enhanced quality for the objects of interest.

Thus, serving entity 302 may render a digital video 316A on client video player 304 by streaming one of a base video 306 (e.g., using an advanced video coding (AVC), a high efficiency video coding, an AOMedia video 1 (AV1), or the like), adaptive bit rate (ABR) streams 308 (e.g., ABR1, ABR2... ABRN), a customized video streams 310 (e.g., object-based coded), base video stream with scalable extension 312, base video or ABR streams with object metadata 314. Further, the rendered video stream with focus on the object of interest is depicted in 316B.

In the example shown in FIG. 3, based on the user input, the football is chosen as an object of interest and a suitable region around the football is zoomed into and displayed, at 316B. The region of interest video will be rendered in such a way that the ball is tracked across the video frames as the ball moves (‘or kicked on’) in the field of play (as long as the object is within the camera view of the original captured content).

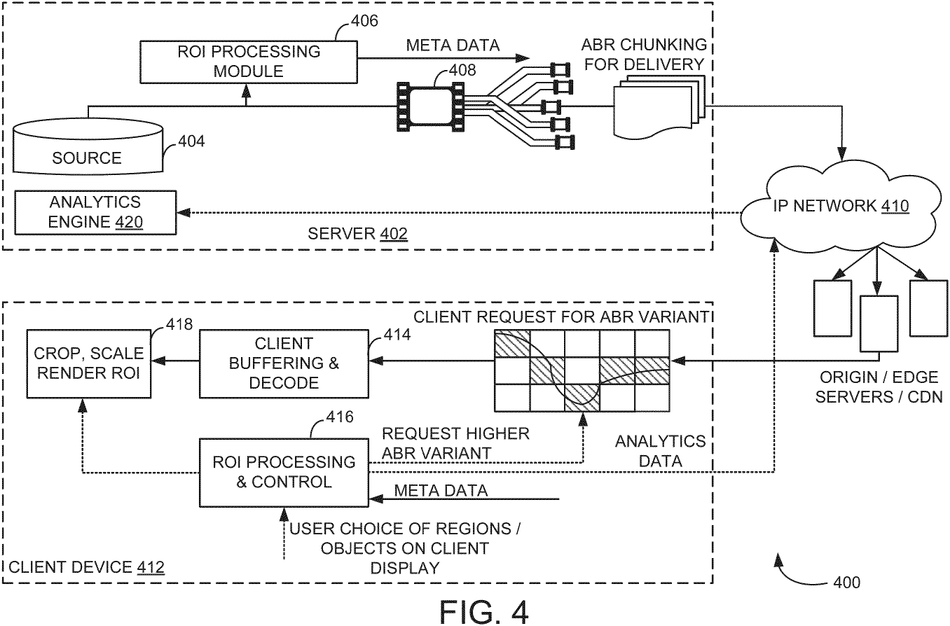

FIG. 4 is a block diagram of another example system 400, depicting a server-client scenario to display video frames of a video stream such that a chosen object/region of interest is shown in a zoomed-in view. As shown in FIG. 4, system 400 includes a server 402 and a client device 412 communicating via an IP network 410. Server 402 includes a video source 404, a region of interest (ROI) processing module 406, and a transcoding module 408. Client device 412 includes a client buffering and decode module 414, ROI processing and control module 416, and a rendering module 418.

Transcoding module 408 may receive the video streams from video source 404. Using adaptive bit rate (ABR) coding, transcoding module 408 may transcode the video streams to ABR streams and publish the ABR streams to a streaming server (e.g., origin, edge server, content delivery network (CDN) and the like) in IP network 410. The streaming server in turn delivers customized streams to an end customer/client device 412. The ABR streams may be produced at various alternative resolutions, bit rates, frame rates, or using other variations in encoding parameters. The ABR streams may be produced in chunks for delivery.

Further, the objects (e.g., a person, a vehicle, and the like) within the video stream/frame that can be tracked as objects of interest by the customers are predetermined at server 402. ROI processing module 406 may perform video analysis on the video stream, detects objects in the video stream, and generates tracking information. ROI processing module 406 may generate metadata conveying the boundary of the object based on the detected objects and the tracking information. The ROI processing module 406 can also form ‘object variants’ of the ABR as an offline video processing step, which involves object detection, segmentation, and tracking for a set of pre-selected, fixed objects in the video or in each of constituent segments. Thus, the ABR variants include ‘object’ variants encompassing the object, i.e., pre-selected fixed objects for the users to be able to select on the client device.

The streaming server may transmit the video stream over IP network 410 to client device 412. IP network 410 may be a local network, the Internet, or other similar network. The display devices include devices capable of displaying the video, such as a television, computer monitor, laptop, tablet, smartphone, projector, and the like. The video stream may pass through an intermediary device, such as a cable box, a smart video disc player, a dongle, or the like. The client device 412 may each remap the received video stream to best match the display and viewing conditions.

Further, the streaming server streams the metadata (for instance, in the form of SEI/VUI messages for MPEG streams such as AVC/HEVC/VVC, or OBU in AV1 streams) about locations of objects of interest along with the standard monolithic video stream (e.g., AVC, HEVC, AV1, and the like). For example, the metadata identifies the top-left and bottom-right corner of the bounding-box for the objects, in terms of macroblock indices, or pixel coordinates. The metadata could also convey the center and radius of a circular boundary of the object of interest. The metadata can also convey the shape and position of an elliptical boundary of the object of interest, with parameters such as an aspect ratio, size, aces information, center of ROI boundary, and the like. The feature can be supported on content formats (e.g., AVC in HLS/DASH) that are already widely deployed and fielded. The metadata generated by ROI processing module 406 at server 402 carries the object position information across video frames for objects in a frame that can be tracked as region of interest by client device 412. As the object of interest moves within the video frame, client device 412 continuously receives the updated location information through the metadata (e.g., using ROI processing and control module 416).

Client buffering and decide module 414 may receive and decode the video stream (e.g., an ABR stream). Further, ROI processing and control module 416 may receive a user selection of the object/region of interest. Furthermore, ROI processing and control module 416 may request for an appropriate ABR variant when the object/region of interest is selected by the user. The appropriate ABR variant, in accordance with the user selection of object, includes higher quality/resolution as well as customized ‘object’ variants corresponding to streams that focus on the objects of interest that can be selected by users on the client device. Once the object of interest is selected by the user at client device 412, with the help of the metadata which provides information for bounding the object, ROI processing and control module 416 forms the boundary (e.g., a bounding box, circle, or ellipse) of the selected object of interest, and can further support zoom and pan for the region of interest. In an example, rendering module 418 may receive the video stream from the client buffering and decide module 414 and receive the boundary information from the ROI processing and control module 416 and then crop and scale the region of interest to focus on the region of interest around the selected object. Further, ROI processing and control module 416 may send feedback information to the streaming server for further analytics. In an example, the analytics may be performed by an analytics engine 420 of server 402.

In an example, a VLC player with necessary updates on a mobile device can be used as an example media client. On a user request for zoom-in of a particular object or region, the media client decodes the metadata to track the object as region of interest. Computation and power requirements on client device 412 to support this feature may be significantly minimal even on lower-end devices and also implying video playback performance may not be hampered with the introduction of this feature.

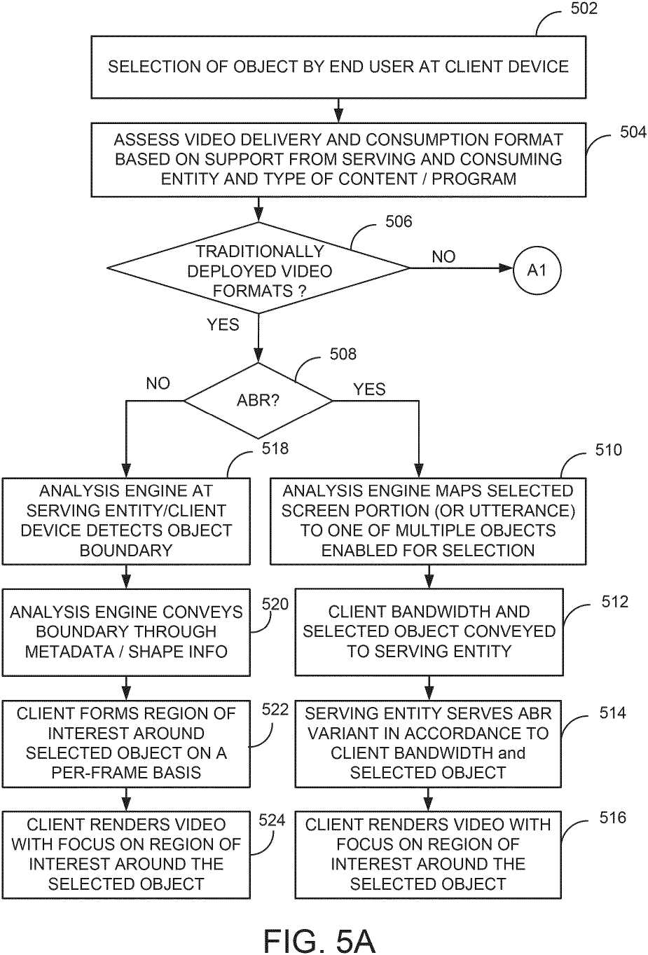

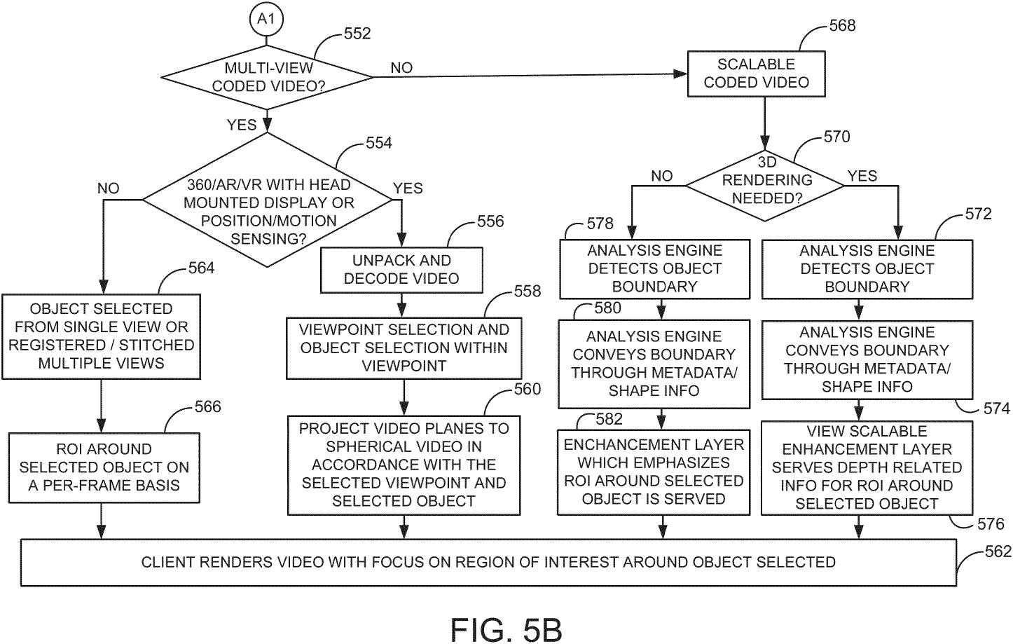

FIGS. 5A and 5B are flow diagrams illustrating an example method for rendering a region of interest on a display panel based on additional visual information. At 502, an object of interest in a first video stream may be selected by an end user at a client device, for instance, via a touch-screen interface, a remote control, a mouse, a gaze detection sensor, a gesture detection sensor, sound source localization techniques based on a plurality of audio/voice signals, or other input to allow a user to select the region of interest.

In response to receiving the selection of the object, at 504, video delivery and consumption format may be assessed based on support from serving and consuming entity and type of content/program (e.g., sports, gaming, and the like) associated with the first video stream.

At 506, a check may be made to determine whether the first video stream corresponds to a traditionally deployed video format. When the first video stream does not correspond to traditionally deployed video formats, then the process shown in FIG. 5B is performed. When the first video stream corresponds to one of the traditionally deployed video formats, at 508, a check may be made to determine whether the first video stream includes an adaptive bitrate (ABR) streaming format.

When the first video stream includes the adaptive bitrate streaming format, at 510, analysis engine (i.e., object-based video processing module 112 of FIG. 1A) may map selected screen portion (or utterance) to one of multiple objects enabled for selection. At 512, a bandwidth associated with the client device and the selected object of interest may be conveyed to a serving entity. At 514, the serving entity may serve an appropriate ABR variant in accordance with the client device’s bandwidth and the selected object. At 516, based on the appropriate ABR variant, the video with focus on the region of interest around the selected object may be rendered on the client device.

When the first video stream does not include the adaptive bitrate streaming format, at 518, analysis engine at the serving entity or the client device may detect an object boundary (e.g., geometric boundary such as a bounding box, circle, or ellipse). At 520, analysis engine conveys the boundary through metadata associated with the object or shape information (e.g., the geometric boundary). At 522, the client device forms a region of interest around the selected object on a per-frame basis. At 524, based on the formed region of interest, the video with focus on the region of interest around the selected object may be rendered on the client device.

As shown in FIG. 5B, when the first video stream does not correspond to traditionally deployed video formats, a check may be made to determine whether the first video stream includes multi-view coded video, at 552. For example, the multi-view video may refer to a collection of multiple videos capturing the same 3D scene at different viewpoints. When the first video stream corresponds to the multi-view coded video, a check is made to determine whether the first video stream includes Virtual Reality (VR), Augmented Reality (AR), or 360° Video with head mounted display or position/motion sensing information, at 554. When the first video stream includes Virtual Reality (VR), Augmented Reality (AR), or 360° Video with head mounted display or position sensing information, at 556, the first video stream may be unpacked and decided. At 558, a viewpoint and an object within the viewpoint may be selected. At 560, video planes may be projected to spherical video in accordance with the selected viewpoint and selected object. Upon projecting the video planes, at 562, the video with focus on the region of interest around the selected object may be rendered on the client device.

When the first video stream does not include Virtual Reality (VR), Augmented Reality (AR), or 360° Video with head mounted display or position sensing information, at 564, the object may be selected from a single view or registered/stitched multiple views. At 566, the region of interest (ROI) around the selected object may be determined on a per-frame basis. Upon determining the region of interest around the selected object, at 562, the video with focus on the region of interest around the selected object may be rendered on the client device.

When the first video stream does not correspond to the multi-view coded video, at 568, the first video stream may be determined as scalable coded video. At 570, a check may be made to determine whether three-dimensional (3D) rendering of the video is needed. If the 3D rendering of the video is needed, analysis engine at the serving entity or the client device may detect an object boundary (e.g., geometric boundary such as a bounding box, circle, or ellipse), at 572. At 574, analysis engine conveys the boundary through metadata associated with the object or shape information (e.g., the geometric boundary). At 576, scalable enhancement layer of the view serves depth related information for the region of interest around the selected object. Further, at 562, the video with focus on the region of interest around the selected object may be rendered on the client device.

If the 3D rendering of the video is not needed, analysis engine at the serving entity or the client device may detect an object boundary (e.g., geometric boundary such as a bounding box, circle, or ellipse), at 578. At 580, analysis engine conveys the boundary through metadata associated with the object or shape information (e.g., the geometric boundary). At 582, enhancement layer which emphasizes the region of interest around the selected object is served. Further, at 562, the video with focus on the region of interest around the selected object may be rendered on the client device.

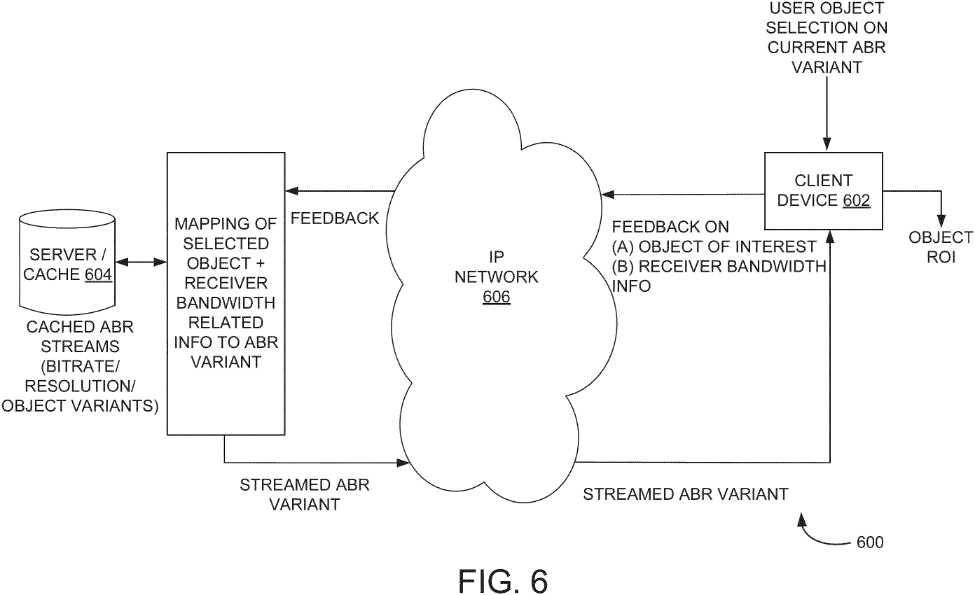

FIG. 6 is a block diagram of an example system 600, including a client device 602 processing a region of interest by requesting for an appropriate variant of ABR stream by augmenting client device’s switching-logic. As shown in FIG. 6, example system 600 may include client device 602 and a server/cache 604 connected via an IP network 606.

During operation, client device 602 may receive, from a user, a selection of an object of interest associated with a current ABR variant that is being rendered on a display panel of client device 602. Upon receiving the selection of the object, client device 602 may send feedback to server 604 via IP network 606. The feedback may include the selected object of interest (e.g., positional information associated with the selected object on the display panel, positional information indicating a boundary of the object, and the like) and receiver’s bandwidth information (i.e., receiving bitrate capability of client device 602). In an example, server 604 may host cached versions of ABR variants with each ABR variant having different bitrate and/or resolution. In some other examples, the cached versions of ABR variants may include object variants encompassing the object, i.e., pre-selected fixed objects for the users to be able to select on client device 602. Such object variants of the ABR can be formed as an offline video processing step, which involves object detection, segmentation and tracking for a set of pre-selected, fixed objects in the video or in each of constituent segments. Example server 604 may include a CDN server, an edge server, and the like. The said object variants along with other ABR variants can be hosted in example server 604.

In an example, server 604 may map the selected object and the receiver’s bandwidth information to an appropriate ABR variant (e.g., an appropriate bitrate and/or resolution variant) of the cached ABR variants. In another example, server 604 may map the selected object and the receiver’s bandwidth information to an appropriate object variant of the cached ABR variants. In this example, the object variant may give the object being tracked in the particular bitrate variant instead of the whole frame. Further, server 604 may retrieve and send the appropriate ABR variant or the appropriate object variant to client device 602 via network 606 based on the mapping. Then, client device 602 may render the region of interest including the object of interest based on the appropriate ABR variant or the object variant.

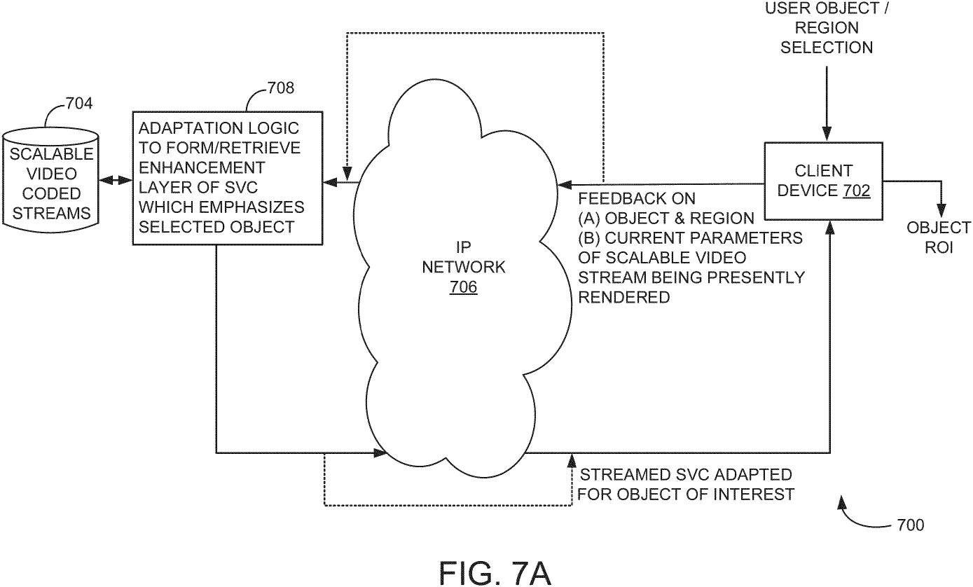

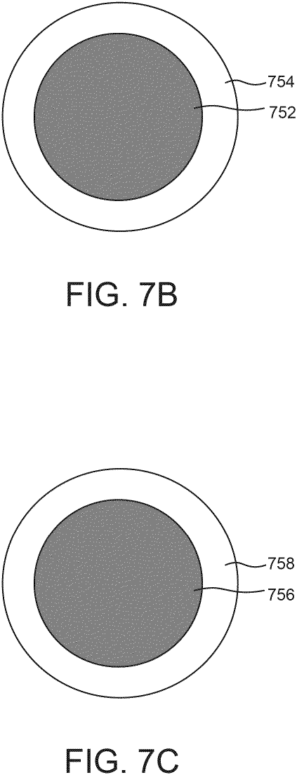

FIG. 7A is a block diagram of an example system 700, including an adaptation logic 708 to provide an appropriate scalable video coding (SVC) stream with enhanced visual details of an object to a client device 702. System 700 includes a client device 702 and a functional server 704 (e.g., a content delivery network (CDN)). In an example, functional server 704 can be connected to client device 702 via an IP network 706. In another example, functional server 704 can be implemented as part of client device 702. In an example, functional server 704 may host multiple SVC streams.

During operation, client device 702 may receive, from a user, a selection of an object/region of interest associated with a current scalable video coding stream that is being rendered on a display panel of client device 702. Upon receiving the selection of the object, client device 702 may send feedback to an adaptation logic 708. In an example, adaptation logic 708 can be implemented as part of functional server 704 or client device 702. The feedback may include the selected object of interest (e.g., positional information associated with the selected object on the display panel, positional information indicating a boundary of the object, and the like) and current parameters of SVC stream being presently rendered (e.g., an amount of bitrate and resolution currently being consumed).

The SVC stream can either be a base layer or one of the multiple enhancement layers. Based on the feedback, adaptation logic 708 may generate or retrieve an enhanced layer of the SVC stream including enhanced visual details of the selected object (i.e., the SVC stream adapted for the object/region of interest) that can be provided to client device 702. Then, client device 702 may render the region of interest including the object of interest based on the SVC stream adapted for the object/region of interest.

Scalable video coding (SVC) techniques are used to enhance the core video compression technologies and to enable scalability in various dimensions. Scalable techniques for progressivity in resolution, bitrate or quality, frame rate, and the like have been proposed and adopted by standards such as AVC/H.264, HEVC, VVC and envisioned in AOM/AV1/AV2 as well. In an example, a base layer of scalable video contains the entire area spanned by complete frame(s) of the video. Once the user choses an object of interest, the enhancement layer can send additional bits to refine that region, imparting higher resolution and effective bitrate, for that region that bounds the object of interest. The SVC may encode the enhancement layer differentially with respect to the base layer, such that, in the examples described herein, the enhancement layer imparts greater clarity and details to the region of interest. In case of certain scalable technologies like motion JPEG2000, position scalability using the construct of ‘precincts’ can be used, to encode the enhancement layer to span only the region that closely bounds the object of interest.

Such scalable video content can be prepared either by (a) dynamically responding to the user-selected object, detecting the object, and preparing the enhancement layers, or (b) statically preparing the enhancement layers for a fixed number of objects, a-priori, among which the user can choose from.

FIG. 7B is a schematic diagram, illustrating an enhancement layer of the scalable video coding scheme. In the example shown in FIG. 7B, 752 may represent a base layer including a first video quality (e.g., a medium visual quality/resolution) for an entire frame of the scalable video stream. 754 may represent an enhancement layer including incremental information associated with a second video quality (e.g., a high quality/resolution) for the geometric boundary including the object of interest within the frame.

FIG. 7C is a schematic diagram, illustrating another example enhancement layer of the scalable video coding scheme. In some examples, stereoscopic or stereo-3D video involves capturing video in stereo pairs in a two-view setup, with cameras mounted side by side and separated by a distance representative of the spacing between a person’s eyes. Examples described in FIG. 7A can be used in the context of stereo-3D as follows. While the capture of stereo-3D video is akin to MVC with a two-view setup, view-scalability principles are used in preferred examples that uses stereo-3D video data. In such a view-scalable setup, the base layer, containing 2D base view, forms ‘one eye view’, say the left-eye-view. The enhancement layer including incremental information could comprise of the ‘other eye view’ (required to complete a stereo-3D video) or depth information in the form of a depth map for the bounding region or boundary of the object of interest. Thus, the object of interest (and associated bounding region) is seen in complete stereo-3D where each constituent part of the object is imparted depth, the regions outside the object of interest (and associated bounding region) get rendered with a static depth, on a 2D plane.

In the example shown in FIG. 7C, 756 represents a base layer containing 2D base view (i.e., base view forms ‘one eye view’ which can be extended to stereo-3D when the ‘other eye view’ becomes available). 758 represents the enhancement layer containing incremental information to form the ‘other eye view’ required to complete a stereo-3D video for the bounding region of object of interest.

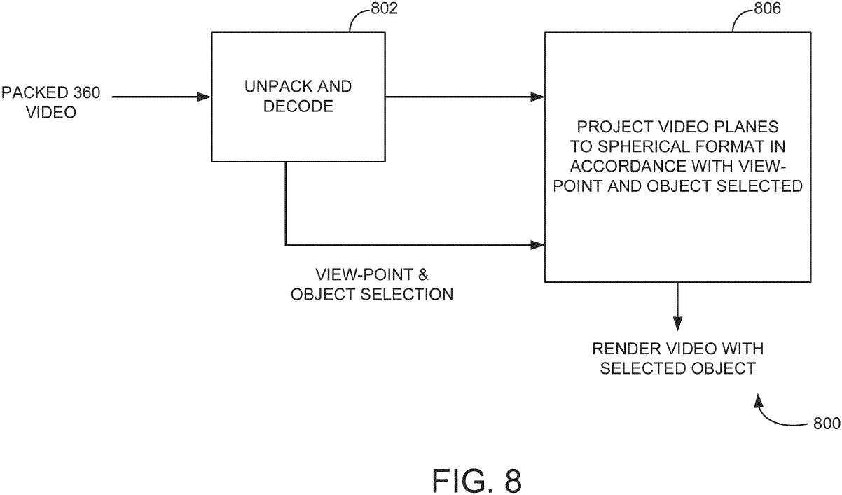

FIG. 8 is a block diagram of an example system 800, depicting processing of a 360 degree-video for rendering a user-selected object of interest on a client device. The 360 degree-videos (or 360-videos) are also known as spherical or surround or immersive videos. The 360-videos may include video recordings where a view in every direction is recorded concurrently using an omnidirectional camera or a collection of cameras which record overlapping angles simultaneously. Such videos subsequently get stitched into one ‘spherical’ video. Rendering such 360-videos using a head mounted display allows adaptation of the viewpoint according to head movements in real time. For the purposes of representation, such videos are unfolded onto 2D using equirectangular projections or cube map projection and get packed subsequently.

FIG. 8 depicts such a packed video with 360 video input to a decoding module 802, which unpacks and decodes the packed 360 video input. The viewpoint is adapted according to head moments of the user in a head mounted display. In the examples described herein, a user can also lock on to a specific object of interest by an appropriate interface operated using hand(s) or other methods such as voice utterances or gaze detection. Further, rendering module 804 may render 2D planar video corresponding to the specific viewpoint as well as the user selected object of interest in a manner such that the rendered region of interest tracks the object of interest in real time.

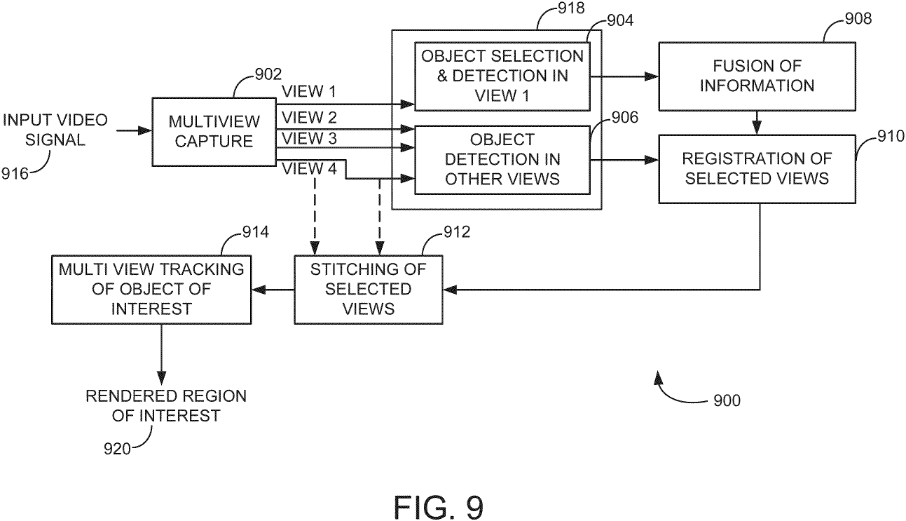

FIG. 9 is a block diagram of an example system 900, depicting stitching of multiple views coming from different camera feeds in Multiview video coding (MVC) technologies to render and track the object of interest. MVC (also known as MVC 3D) is a stereoscopic video coding standard for video compression that allows for the efficient encoding of video sequences captured simultaneously from multiple camera angles in a single video stream.

As shown in FIG. 9, an input visual or video signal 916 may be captured using a multi view capture mechanism 902. For example, video signal 916 may be captured using multiple camera feeds. The output of multi view capture mechanism 901 may include multiple views (e.g., view 1, view 2, view 3, and view 4 as shown in FIG. 9). Further, object detection module 918 may use view 1 for object selection by the end user such that the end user clicks or selects a portion of a display panel that is within or in close proximity of that object, at 904. Furthermore, object detection module 918 may perform the object detection in view 1, which identifies the object associated with that region chosen by the user. This object is correlated and detected in other view (e.g., view 4). Fusion module 908 is responsible for fusion of information across the views which contain the selected object. This involves the identification of matching key points and the geometric warping of pictures, in order to perform the operation of registration of relevant views using registration module 910. Stitching module 912 is responsible for stitching together of selected views. In some examples, the optimum stitching path, based on minimum sample difference and depth cues for appropriate occlusion handling, is performed, by minimizing or avoiding temporal variation of stitching path. In some other examples, blending, filtering, or hole filling may be needed to mask artifacts. Upon stitching the selected views, tracking, and rendering module 914 may performs tracking of the object of interest using the information from the multiple views. In case a chosen object is only partially found in a particular view, the complete object can be found in the stitched view. Further, tracking and rendering module 914 may render the region of interest 920 that encompasses the object, which is tracked across the frames (e.g., on a frame-by-frame basis).

FIG. 10 shows an indicative object and two traditional rectangular partitions, within which the triangular or trapezoidal or wedge shape splits help in aligning to the boundaries of the object (e.g., 1004) closely. The motion field of a picture in a video sequence is usually segmented by the boundaries of moving objects. This is because objects may exhibit movement relative to a static background or other moving objects, and object boundaries in natural sequences rarely adhere to rectangular block patterns. Boundaries of the moving objects are often difficult to be approximated by on-grid rectangular block partitions. Some video compression standards may have the ability to partition blocks beyond the rectangular partitions.

FIG. 10 shows an indicative object and two traditional rectangular partitions, within which the triangular or trapezoidal or wedge shape splits help in aligning to the boundaries of the object closely. In Versatile Video Coding (VVC), Geometric mode (GEO) is selected on the object edge, and the partition mode has a strong correlation with the object boundaries.

In AV1, a codebook of 16 possible wedge partitions has been predefined. The wedge index is signaled in the bitstream when a coding unit chooses to be further partitioned in such a way. 16-ary shape codebooks containing partition orientations that are either horizontal, vertical, or oblique with slopes ±2 or ±0.5 are supported in AV1. Some video compression standards support more of such geometric, non-rectangular splits, where the examples described herein can leverage such splits and post-process them (using edge linking and boundary tracing algorithms) to determine the object boundaries closely. In the example shown in FIG. 10, 1002 represents non-rectangular splits of partitions whose boundaries lie on the object of interest. Information pertaining to non-rectangular splits can also be used in conjunction with various objects which have been learned using artificial intelligence.

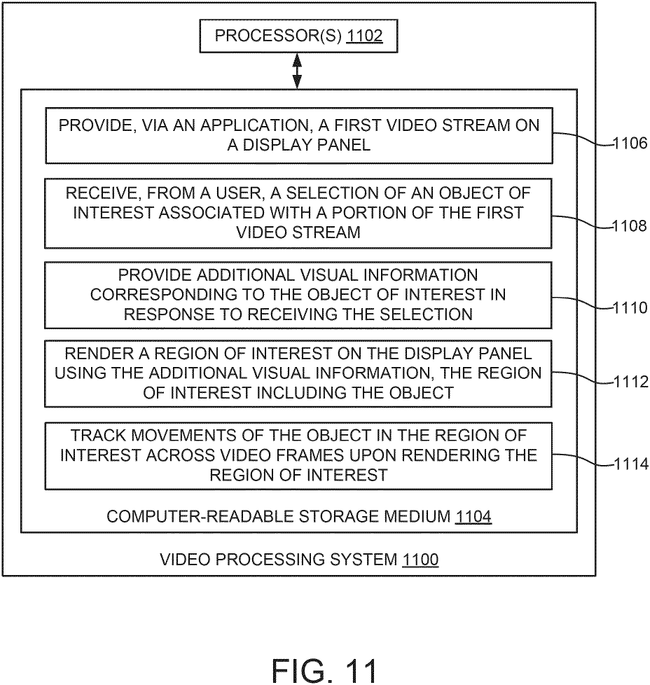

FIG. 11 is a block diagram of an example video processing system 1100 including non-transitory computer-readable storage medium 1104 storing instructions to render a region of interest on a display panel using additional visual information. Video processing system 1100 may include a processor 1102 and computer-readable storage medium 1104 communicatively coupled through a system bus. Processor 1102 may be any type of central processing unit (CPU), microprocessor, or processing logic that interprets and executes computer-readable instructions stored in computer-readable storage medium 1104. Computer-readable storage medium 1104 may be a random-access memory (RAM) or another type of dynamic storage device that may store information and computer-readable instructions that may be executed by processor 1102. For example, computer-readable storage medium 1104 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 1104 may be a non-transitory computer-readable medium. In an example, computer-readable storage medium 1104 may be remote but accessible to video processing system 1100.

Computer-readable storage medium 1104 may store instructions 1106, 1108, 1110, 1112, and 1114. Instructions 1106 may be executed by processor 1102 to provide, via an application, a first video stream on a display panel. Instructions 1108 may be executed by processor 1102 to receive, from a user, a selection of an object of interest associated with a portion of the first video stream.

In response to receiving the selection, instructions 1110 may be executed by processor 1102 to provide additional visual information corresponding to the object of interest. For example, the additional visual information may include one of an enhancement layer of a scalable video coding (SVC) scheme, a higher adaptive bitrate streaming (ABR) variant, an object mask identifying the object, metadata associated with the object, object-based coded stream representing objects, and multi-view information in Multiview Coding (MVC) scheme;

Further, instructions 1112 may be executed by processor 1102 to render a region of interest on the display panel using the additional visual information and the region of interest including the object. Upon rendering the region of interest, instructions 1114 may be executed by processor 1102 to track movements of the object contained in the region of interest across video frames.

Some or all of the system components and/or data structures may also be stored as contents (e.g., as executable or other computer-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
providing, via an application, a first video stream on a display panel of a user device;
receiving, from a user, a selection of an object of interest associated with a portion of the first video stream;
in response to receiving the selection, providing additional visual information corresponding to the object of interest, wherein the additional visual information comprises one of an enhancement layer of a scalable video coding (SVC) scheme, a higher adaptive bitrate streaming (ABR) variant, an object mask identifying the object, metadata associated with the object, object-based coded stream representing objects, and multi-view information in Multiview Coding (MVC) scheme;
rendering a region of interest on the display panel using the additional visual information and the region of interest including the object; and
upon rendering the region of interest, tracking movements of the object in the region of interest across video frames.

2. The method of claim 1, wherein the first video stream comprises one of:
a file on a file system in the user device;
an Internet video that is being delivered over an internet protocol in a managed network or in an over-the-top (OTT); and
a video within a video collaboration tool, whereby the user zooms into a specific object/region of interest to examine details of the video, infographics, text, or other visual media being communicated via the video collaboration tool.

3. The method of claim 1, wherein the object is obtained based on partitions contained in the first video stream and wherein the first video stream is compressed video stream containing I-frame data, P-frame data, B-frame data, or any combination thereof.

4. The method of claim 1, wherein tracking the movements of the object in the region of interest comprises tracking the object as the object moves or changes across the video frames and rendering the tracked object in a zoomed-in view.

5. The method of claim 1, wherein rendering the region of interest on the display panel comprises:
in response to receiving the selection of the region of interest, sending a request for the additional visual information to the server;
based on the request, receiving a second video stream directed to the same video content as the first video stream, wherein the second video stream comprises the additional visual information, wherein the additional visual information comprises a higher bitrate/resolution variant including enhanced visual details to enable the user to zoom into the object of interest on the display panel; and
rendering the region of interest associated with a portion of the second video stream on the display panel.

6. The method of claim 1, wherein rendering the region of interest on the display panel comprises:
in response to receiving the selection of the region of interest:
detecting a plurality of objects in the first video stream;
determining an object of the plurality of objects that corresponds to the region of interest;
generating the additional visual information corresponding to the determined object, wherein the additional visual information comprises one of a geometric boundary around the object, the enhancement layer of the scalable video coding (SVC) scheme, and the object mask identifying the object; and
panning and zooming the first video stream to display the object on the display panel based on the additional visual information.

7. The method of claim 1, wherein rendering the region of interest on the display panel comprises:
receiving, from a server, the first video stream along with the additional visual information associated with objects in the first video stream, the additional visual information comprising the metadata including a position information of the objects across the video frames of the first video stream that can be used to track the movements of the object; and
in response to receiving the selection of the region of interest, rendering the region of interest including the object using the metadata associated with the object.

8. The method of claim 7, further comprising:
determining a geometrical boundary around the object or the object mask of the object using the received metadata; and
panning and zooming the first video stream according to the geometrical boundary or the object mask to display the region of interest including the object on the display panel.

9. The method of claim 7, wherein the object is signaled to the user device in the form of the metadata conveying a geometrical boundary of the object.

10. The method of claim 7, wherein the object is signaled to the user device in the form of the metadata conveying boundaries of the object in the form of the object mask.

11. The method of claim 1, wherein rendering the region of interest on the display panel comprises:
receiving, from the server, the first video stream along with the additional visual information, wherein the additional visual information comprises object-based coded streams representing objects in the first data stream; and
in response to receiving the selection of the object of interest, panning, and zooming the first video stream to display a boundary of the object on the display panel, the boundary including an object-based coded stream representing a zoomed portion of the object.

12. The method of claim 11, wherein rendering the region of interest comprises:
rendering arbitrarily shaped object-based coded streams with boundaries demarcated at pixel level or partition-block level.

13. The method of claim 1, wherein rendering the region of interest on the display panel comprises:
providing the first video stream including a base layer of the scalable video coding scheme on the display panel; and
in response to receiving the selection of the region of interest, providing the additional visual information including the at least one enhancement layer of the scalable video coding scheme on the display panel, wherein the at least one enhancement layer provides details associated with the object of interest.

14. The method of claim 13, wherein the base layer comprises a first visual quality or resolution for the video frames of the first video stream, and wherein the enhancement layer comprises an enhanced visual quality or resolution for a bounding region of the object of interest.

15. The method of claim 13, wherein the base layer comprises a 2D base view forming “one eye view” of a stereo-3D video, and wherein the enhancement layer comprises incremental information pertaining to a depth of a bounding region of the object of interest, wherein depth information associated with the depth of the bounding region is conveyed via an “other eye view” or a depth map.

16. The method of claim 1, wherein the first video stream is associated with an augmented reality (AR), virtual reality (VR), or gaming application.

17. The method of claim 1, further comprising:
using an artificial intelligence (Al)-based analysis tool to:
enable recognition and segmentation of the object of interest in the first video stream; and
determining a window that covers the object of interest.

18. The method of claim 17, wherein the recognition and segmentation can be performed at a serving entity that generates the first video stream or at the user device that displays the first video stream.

19. The method of claim 1, further comprising:
receiving feedback associated with the object of interest selected by the user; and
using the feedback for further analytics pertaining to the object of interest.

20. The method of claim 1, wherein the first video stream comprises digital video that is encapsulated in adaptive bitrate streams, on which the region of interest would be achieved using client-side processing, wherein the adaptive bitrate streams comprise chunks of video data, each chunk encapsulating independently decodable Advanced Video Coding (AVC), High Efficiency Video Coding (HEVC), AOMedia Video (AV1 or AV2), or Versatile Video Coding (VVC).

21. The method of claim 1, wherein rendering a region of interest on the display panel comprises:
based on the additional visual information, generating high quality video frames using a deep learning based super resolution to render the object of interest on the client side.

22. The method of claim 1, wherein when the object is available partially in multiple views captured from different camera feeds in Multiview coding (MVC) technologies, registering and stitching the views together to form the object, which is then rendered and tracked in the region of interest.

23. The method of claim 1, wherein the additional visual information is generated at the user device or at a serving entity that serves the first video stream.

24. A video processing system comprising:
a display panel;
a processor; and
memory coupled to the processor, wherein the memory comprises an object-based video processing module to:
provide, via an application, a first video stream on the display panel;
receive, from a user, a selection of an object of interest associated with a portion of the first video stream;
in response to receiving the selection, provide additional visual information corresponding to the object of interest, wherein the additional visual information comprises one of an enhancement layer of a scalable video coding (SVC) scheme, a higher adaptive bitrate streaming (ABR) variant, an object mask identifying the object, metadata associated with the object, object-based coded stream representing objects, and multi-view information in Multiview Coding (MVC) scheme;
render a region of interest on the display panel using the additional visual information, the region of interest including the object; and
upon rendering the region of interest, track movements of the object in the region of interest across video frames.

25. A non-transitory computer-readable storage medium having instructions executable by a processor of a video processing system to:
provide, via an application, a first video stream on a display panel;
receive, from a user, a selection of an object of interest associated with a portion of the first video stream;
in response to receiving the selection, provide additional visual information corresponding to the object of interest, wherein the additional visual information comprises one of an enhancement layer of a scalable video coding (SVC) scheme, a higher adaptive bitrate streaming (ABR) variant, an object mask identifying the object, metadata associated with the object, object-based coded stream representing objects, and multi-view information in Multiview Coding (MVC) scheme;
render a region of interest on the display panel using the additional visual information and the region of interest including the object; and
upon rendering the region of interest, track movements of the object in the region of interest across video frames.
